(19) United States
(12) Patent Application Publication
(10) Pub. No.: US 2003/0002840 A1
(43) Pub. Date: Jan. 2, 2003

(54) Electrical bond system for fiber-optic tubing

(75) Inventor: John W. Auclair, Norfolk, CT (US)

Correspondence Address: ALIX YALE & RISTAS LLP, 750 MAIN STREET, SUITE 1400, HARTFORD, CT, 06103, US

(73) Assignee: Electric Motion Company, Inc.

(21) Appl. No.: 09/895,737

(22) Filed: Jun. 29, 2001

(51) Int. Cl. G02B 6/00

(52) U.S. Cl. 385/136; 385/147

(57) ABSTRACT

A bond clamp assembly for a mini fiber-optic metallic conduit employs a pair of cooperative jaws. The jaws are configured so that a wide range of mini fiber-optic conduits may be received therein and clamped in a stable clamp configuration. In one embodiment, one of the jaws is defined by a concave surface of a retainer plate which connects with flexible conductor. In another embodiment two clamp members are slidably engaged by a cylindrical tongue and groove arrangement of the two clamp members.

### BACKGROUND OF THE INVENTION

This invention relates generally to devices and methods for implementing electrical or ground connections with the metallic conduits employed for fiber-optic communication. More particularly, this invention relates to bonding devices and methods for metal tubing which is relatively small in diameter and accommodates only a few fiber optical strands.

As the use and popularity of fiber-optic cables in communication systems have become widespread, the communication networks that employ fiber-optic lines have involved cables of relatively large diameter. These cables accommodate numerous optic-fibers and are typically surrounded by a steel shield or pipe which has an outer cover manufactured of non-conductive materials such as plastic. As more and more communication networks have been installed, it has become clear that there may be, at least in the short term, an over-capacity of fiber-optic capacity.

For numerous communication applications, it is clearly not required that large numbers of fiber-optics be installed. Accordingly, there has recently been a trend to fiber-optics communication networks which employ a few fiber-optic strands installed in a stainless steel or metal tube of a relatively small diameter as compared to the majority of fiber-optics cable installations. For such installations, continuous coils of stainless steel tubing are typically employed. It is, of course, necessary to provide an electrical bond between sections of the stainless tubing and also to provide adequate ground connection. Such electrical bonding and ground connections have been employed to date by devices adapted from other ground and bond applications and are not fully adapted for the new low capacity installation involving the use of stainless steel tubing, which may typically contain from 2-60 fibers and have an inside diameter 1.5 millimeters to 3.6 mm and an outside diameter 1.7 to 3.9 mm. It is for this latter type of application termed “mini fiber-optic conduit” that the invention has particular applicability.

### SUMMARY OF THE INVENTION

Briefly stated, the invention in a preferred form is a bond clamp assembly which provides a bond or ground connection for a mini fiber-optic metal conduit for one or more optic fibers. The clamp assembly comprises a base defining a first jaw with a first contour which is generally symmetrical along a transverse axis. A threaded stud projects orthogonally from the base. A cap defines a second jaw and has a second contour comprising a concave surface. The concave surface is disposed along a second transverse receiving axis with the second contour having a different configuration on the first contour and being generally alignable therewith. The cap also has an aperture for receiving the stud. A conductor is connected to the cap and extends generally laterally therefrom. A retainer such as a nut is threably engageable with the stud to clamp the jaws against a mini fiber-optic conduit received between the jaws and which extends generally transversely thereto so that the conduit is clamped in a stable clamped relationship. The cap may have a generally J-shaped profile.

In another embodiment of the invention, the bond clamp assembly employs a first clamp member which defines a jaw having a contour along a first transversely extending receiving axis. An integral generally cylindrical tongue defines an interior thread and projects orthogonally relative to the receiving axis. A second clamp member has a jaw with a second contour different from the first contour and generally alignable therewith. The second clamp member has a generally cylindrical groove complementary with the cylindrical tongue and slidably engageable therealong. A connector connects a wire conductor and defines an aperture. A fastener, such as a screw, threadably engages with the threaded surface and has a shoulder which engages the connector to clamp the jaws against a mini fiber-optic conduit receivable therein.

The first clamp member may define a clamping receptacle defined by a pair of parallel side walls and a central concave surface disposed between a pair of convex surfaces which intersect the side wall. The second clamp jaw has a clamp receptacle defined by a pair of laterally spaced, generally parallel, transversely extending planar clamp strips and a central parallel clamp strip deposed between the pair of intersecting diagonal clamp surfaces.

An object of the invention is to provide a new and improved bond system for fiber-optic conduits having a small diameter.

Another object of the invention is to provide a new and improved bond system for connecting and grounding fiber-optic tubing for which a single device can effectively accommodate a range of differently dimensioned metal tubes.

A further object of the invention is to provide a new and improved bond device which provides an electrical bond of high integrity and reliability.

A further object of the invention is to provide a new and improved bond device which may be installed in an efficient manner and has an efficient low cost construction.

Other objects and advantages of the invention will be apparent from the detailed description and the drawings.

### BRIEF DESCRIPTION OF THE DRAWINGS

FIG. 1 is a perspective fragmentary view of an electrical bond clamp assembly installed on a mini fiber-optic conduit in accordance with the present invention;

FIG. 2 is a perspective fragmentary view of the electrical bond clamp assembly of FIG. 1 installed on a larger mini fiber-optic conduit having a larger diameter;

FIG. 3 is a perspective exploded fragmentary view of the electrical bond clamp assembly of FIG. 1;

FIG. 4 is a perspective view of the electrical bond clamp assembly of FIG. 1;

FIG. 5 is a fragmentary side elevational view, partly in schematic, illustrating the contour geometry of the clamp elements of the electrical bond assembly of FIG. 1;

FIG. 6 is a perspective fragmentary view of a second embodiment of an electrical bond clamp assembly installed on a mini fiber-optic conduit in accordance with the invention;

FIG. 7 is a perspective fragmentary view of the electrical bond clamp assembly of FIG. 6 installed on a mini fiber-optic conduit having a larger diameter;

FIG. 8 is an exploded perspective view of the electrical bond clamp assembly of FIG. 6;

FIG. 9 is a perspective view of the electrical bond clamp assembly of FIG. 6; and

FIG. 10 is a fragmentary side elevational view, partly in schematic, illustrating the clamp contour geometry of the electrical bond clamp assembly of FIG. 6.

### DETAILED DESCRIPTION OF THE INVENTION

With reference to the drawings wherein like numerals represent like parts throughout the several figures, an electrical bond clamp assembly in accordance with the present invention is generally designated by the numeral 10. The bond clamp assembly 10 is especially adapted for installation to the metallic shield or mini fiber-optic conduit 12. Such a mini fiber-optic conduit may, for example, house as few as two optic fibers 14 within a stainless steel tubing having an inside diameter of 1.5 mm and an outside diameter of 1.7 mm and as many as sixty optical fibers within a stainless steel tubing having an inside diameter of 3.6 mm and an outside diameter of 3.9 mm.

Even within the mini fiber-optic tube environment there can typically be some variation in tube diameter. Because of the relatively small tube diameter in relation to conventional fiber-optics cables, it is highly desirable to provide a bond clamp assembly which provides a highly effective electrical bond connection for a wide variety of tube sizes, but is configured so it can be easily installed and does not crush the small fiber-optic conduit.

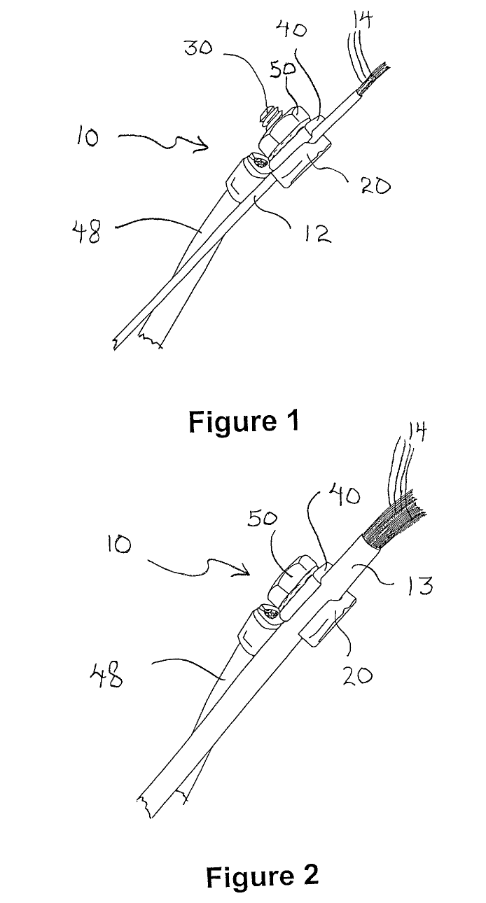

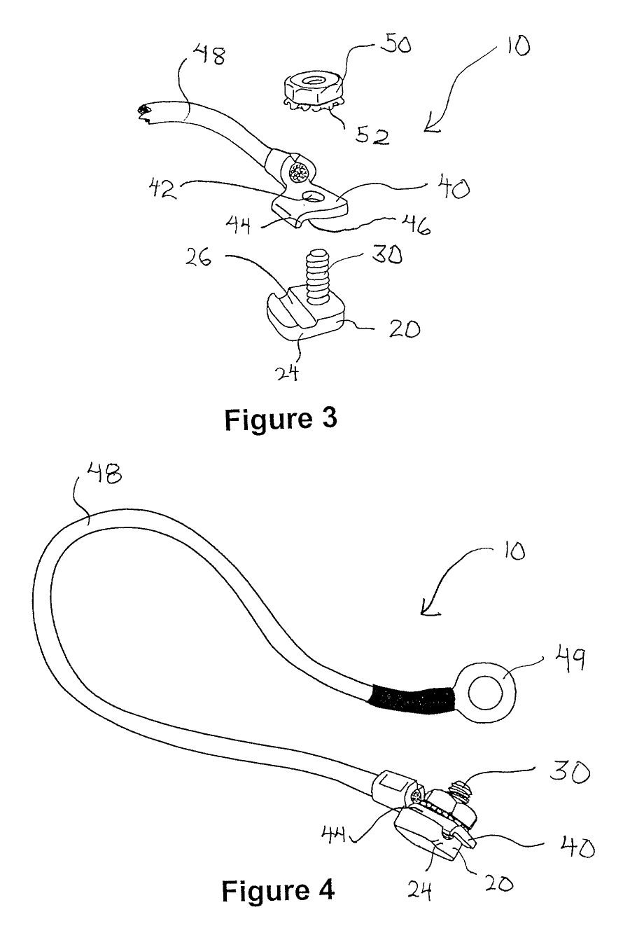

As shown in FIGS. 1 and 2, a given electrical bond clamp assembly 10 can be effectively installed on fiber-optic cables which employ mini fiber-optic conduits 12 and 13 wherein each has a different diameter. The fiber-optic clamp assembly 10 comprises a base 20, which defines a longitudinal receiving jaw 24 having a specific contour 26. The contour 26 extends generally uniformly along a transverse axis. A threaded stud 30 projects orthogonally from the base.

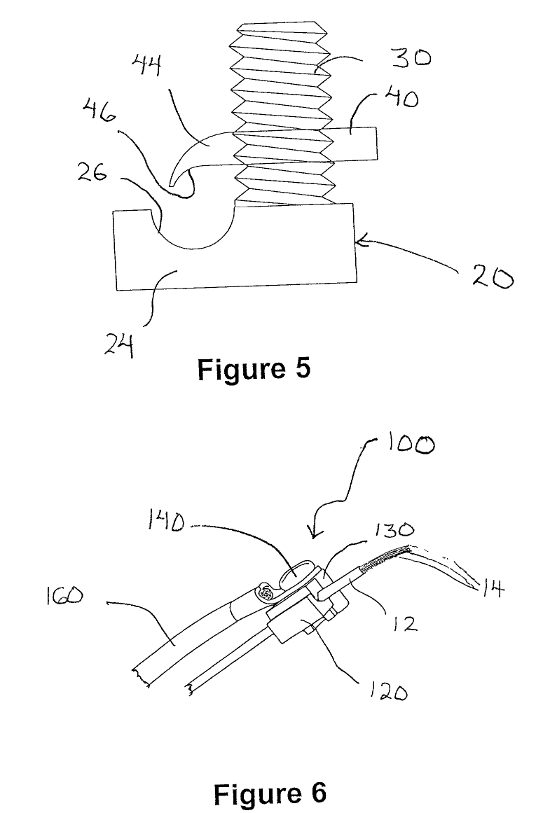

A retainer plate or cap 40 defines a clamp jaw 44 and has an integral crimp structure which connects with a flexible wire 48. A ring terminal 49 may be mounted at the free end of the wire 48. The retainer plate or cap 40 has a generally J-shaped profile illustrated in FIG. 5. The retainer plate 40 includes an aperture 42 which receives the stud 30. The clamp jaw 44 of the retainer plate has a convex bent form at the underside, as best illustrated in FIG. 5, which shows the relationship between the jaw contour 26 of the base and the jaw contour 46 of the retainer plate. The jaws 24 and 44 form a transverse cradle for the mini filter-optic conduit. The radius of curvatures in the contours 26 and 46 are selected so that the jaws can receive and clamp against a wide variety of conduit diameters in the range of, for example 1.7 to 3.9 mm, while providing a firm and reliable electrical connection of high mechanical and conductive integrity.

A nut 50 and a lockwasher 52 secure the retainer plate 40 to the stud 30 and, upon tightening, clamp the plate against the mini fiber-optic conduit 12 or 13 which is disposed between the jaws 44 and 24 of the retainer plate 40 and the base 20.

The clamp assembly 10 is formed of tinplated copper to provide a complementary conductive connection with the stainless steel shield. The bond clamp fits all sizes within the mini fiber-optic conduit range and incorporates a ring terminal in the upper jaw in a highly efficient manner. The connector also provides a relatively large footprint around the received conduit 12 and 13 so that upon clamping the nut 50, a compressive force is distributed over a relatively great clamp interface area via contours 26 and 46, so that the received conduit will not be compressed while being retained in a stable clamped relationship.

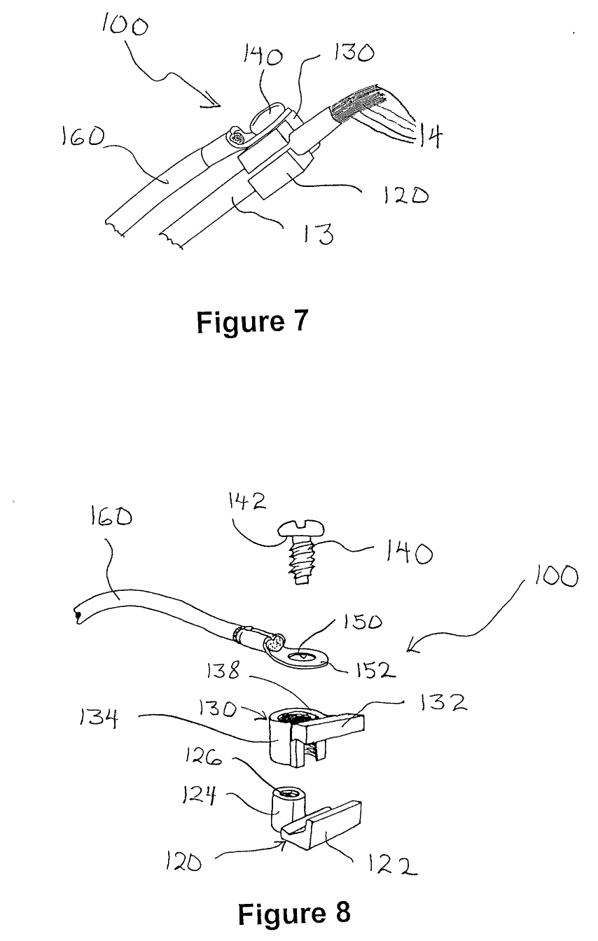

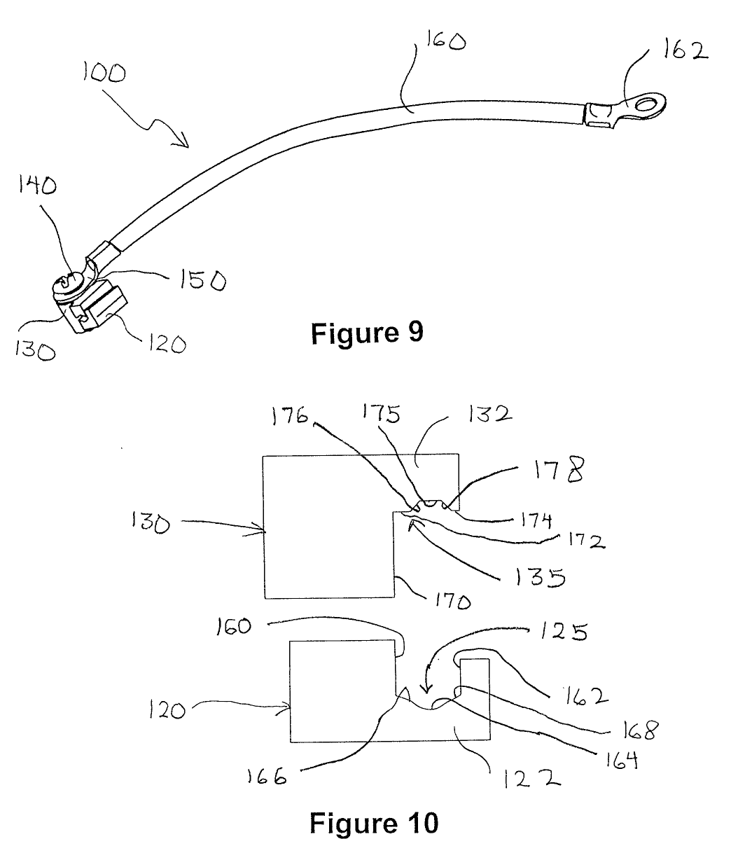

With reference to FIGS. 6 through 10, a second embodiment of an electrical bond clamp bond assembly is generally designated by the numeral 100. Bond clamp assembly 100 comprises a pair of cooperative clamp members 120 and 130 which cooperate to receive and clamp the received fiber-optic cable 12 or 13 as illustrated in FIGS. 6 and 7. A given bond clamp assembly 100 may be employed for both smaller and larger diameter mini fiber-optic conduits 12 and 13.

With additional reference to FIG. 8, the base clamp member 120 includes a jaw like portion 122 and a cylindrical, integrally connected, orthogonally projecting connector 124. The interior of the connector 124 has a threaded bore 126. The upper clamp member 130 includes a jaw like extension 132 and a cylindrical yoke 134. The yoke 134 has an interior cylindrical surface which is complementary with the exterior surface of connector 124 to allow for a sliding reception therewith.

A threaded fastener 140 is inserted through the aperture 152 of a ring connector 150, which attaches to a flexible wire 160. The ring connector 150 is forced against the planar annular top 138 of the clamp member 130. The fastener shoulder 142 engages the ring connector 150 and threads with the connector bore 126 to secure the clamp assembly 100 in a clamped configuration against a received fiber-optic conduit 12 or 13. The clamp assembly also provides an efficient electrical bond. It will be appreciated that the connector 124 and yoke 134 slideably engage in a tongue and groove-type connection. The connector 124 and yoke 134 provide an engagement which is stable about the orthogonal axis. A second ring terminal 162 may be fixed to the free end of wire 160.

With reference to FIG. 10, the respective jaws 122 and 132 of the clamp members each have a well defined specific geometric contour 125 and 135 which cooperates to clamp a received fiber-optic conduit 12 or 13 in a stable clamp position to provide an electrical and mechanical connection of high integrity without crushing the conduit. The jaw contours 125 and 135 extend transversely, generally uniformly to define the receiving cavity for the fiber-optic conduit. Jaw contour 125 is defined by a pair opposite parallel walls 160 and 162 and a quasi U-shaped lower wall comprised of a concave central portion 164 and opposed slightly convex surfaces 166 and 168. The opposing jaw contour 135 includes a wall 170, which generally aligns with wall 160 and an integral upper portion including upper coplanar walls 172 and 174 and a recessed upper clamp surface 175 which connects with pair of diagonal surfaces 176 and 178. It should be appreciated that the specific jaw configuration provides both a stable cradle for the received conduit 12 or 13 and a large compressive area so that the compressive force may be distributed over a relatively large area without compressing the conduit 12 or 13. The clamp assembly 100 may thus be employed for a wide range of mini fiber-optic conduits.

The clamp members 120 and 130 for one embodiment of the clamp assembly 100 are manufactured from bronze. Alternately, the members 120 and 130 could also be zinc cast members with a tin plate.

While preferred embodiments of the foregoing bond clamp assemblies have been set forth for purposes of description, the foregoing description should not be deemed a limitation in the invention herein. Accordingly, various modification, adaptation, and alternatives may occur to one skilled in the art without departing from the spirit and the scope of the present invention.

What is claimed is:

1. A bond clamp assembly for providing an electrical bond connection for a mini fiber-optic metal conduit for one or more optic fibers comprising:
a base defining a first jaw having a first contour which is generally symmetrical along a transverse axis;
a threaded stud projecting orthogonally from said base;
a cap defining a second jaw and having a second contour comprising a concave surface which is disposed along a second transverse receiving axis, said second contour having a different configuration than said first contour and being generally alignable therewith, said cap further defining an aperture for receiving the stud;
a conductor connected to said cap and extending therefrom; and
a retainer threadably engageble with said stud to clamp the jaws against a mini fiber-optic conduit received between said jaws and extending generally transversely thereto wherein said conduit is clampable in a stable clamped relationship.

2. The bond clamp assembly of claim 1 wherein said cap has a generally J-shaped profile.

3. The bond clamp assembly of claim 1 wherein said first contour is defined by a generally arcuate surface forming a transverse groove.

4. The bond clamp assembly of claim 1 wherein said retainer is a nut.

5. The bond clamp assembly of claim 1 wherein said conductor is connected to said cap by an integral crimp connection.

6. A bond clamp assembly for providing an electrical bond connection for a mini fiber-optic metal conduit for one or more optic fibers comprising:
a first clamp member defining a first jaw having a first contour along a first transversely extending receiving axis and having a generally cylindrical tongue defining an interior thread and projecting othogonally relative to said receiving axis;
a second clamp member defining a second jaw having a second contour different from said first contour and generally alignable therewith, said second clamp member defining a generally cylindrical surface complementary with said cylindrical tongue and slidably engageable therealong;
a connector connecting a conductor and defining an aperture; and
a fastener threadably engageable with said threaded surface and having a shoulder which engages said connector and is threadably engageable with said thread to clamp said jaws against a mini fiber-optic conduit receivable therebetween.

7. The bond clamp assembly of claim 6 wherein said first clamp member clamp defines a clamping receptacle defined by a pair of parallel side walls and a central concave surface disposed between a pair convex surfaces which intersect said side wall.

8. The bond clamp assembly of claim 6 wherein said second clamp jaw comprises a clamp receptacle defined by a pair of laterally spaced generally parallel transversely extending planar clamp strips, and a central parallel clamp strip disposed between a pair of intersecting diagonal clamp surfaces.

9. The bond clamp assembly of claim 6 wherein said connector is a ring-type terminal.

10. The bond clamp assembly of claim 6 wherein said fastener is a screw.
